(19) United States
(12) Patent Application Publication
(10) Pub. No.: US 2009/0016454 A1
(43) Pub. Date: Jan. 15, 2009

(54) TIME DE-INTERLEAVER IMPLEMENTATION USING AN EMBEDDED DRAM IN A TDS-OFDM REC

(75) Inventors: YAN ZHONG, SAN JOSE, CA (US); HAIYUN YANG, SAN JOSE, CA (US)

Correspondence Address: FRANK F. TIAN, 331-4A THIRD AVENUE, LONG BEACH, NJ, 07740, US

(73) Assignee: LEGEND SILICON, FREMONT, CA (US)

(21) Appl. No.: 11/775,486

(22) Filed: Jul. 10, 2007

(51) Int. Cl. H04K 1/10

(52) U.S. Cl. 375/260

(57) ABSTRACT

A receiver having a de-interleaver with a processor for processing interleaved data; and a built-in eDRAM coupled to the processor for processing the interleaved data is provided.

### FIELD OF THE INVENTION

The present invention relates generally to de-interleavers with embedded eDRAM. More specifically, the present invention relates to a time de-interleaver with embedded eDRAM implementation within a finite state machine (FSM) in a Time Domain Synchronous Orthogonal Frequency Division Multiplexing (TDS-OFDM) receiver.

### BACKGROUND

Typically for a Time domain synchronous-Orthogonal frequency-division multiplexing (TDS-OFDM) receiver, time-deinterleaver is used to increase its resilience in its ability to withstand spurious noise. For example, a typical time-deinterleaver with a convolutional de-interleaver needs a memory with size B*(B−1)*M/2 where B is the number of the branch, and M is the depth. Since the required time-deinterleaver length is generally very long, generally instead of using a large on-chip memory, it is desirous to use a cost-effective stand alone or commercially available SDRAM chip for storing the data. But in this invention, a large embedded eDRAM is used.

eDRAM stands for “embedded DRAM” is known. eDRAM comprises a capacitor-based dynamic random access memory usually integrated on the same die or in the same package as the main ASIC or processor, as opposed to external DRAM modules and transistor-based SRAM typically used for caches. The latest developments overcome this limitation by using standard CMOS process to manufacture eDRAM, as in 1T-SRAM. Compared with external stand-alone DRAM, embedding large blocks of DRAM into ASIC brings many advantages. First, it eliminates the need to drive I/O signals to separate memory chips, so that it reduces the system-board size and simplifies the system-board design complexities. Second, eDRAM boosts memory performance and overall system bandwidth. Third, it is easier to be used in a hand-held device system.

U.S. patent application Ser. No. 11/677,225 assigned to the same assignee, entitled TIME DE-INTERLEAVER IMPLEMENTATION USING SDRAM IN A TDS-OFDM RECEIVER, describes a independent SDRAM. The aforementioned application is hereby incorporated herein by reference. However, an independent SDRAM necessarily takes larger footprint, consumes more power, or subject to external memory shortage.

Therefore, it is desirable to have an embedded or built-in memory capable of accommodating non-identical word width.

### SUMMARY OF THE INVENTION

A Time-Deintleaver with embedded memory having less footprint, consumes less power, or not subject to external memory shortage is provided.

In a TDS-OFDM receiver, a Time-Deintleaver with embedded memory having less footprint, consumes less power, or not subject to external memory shortage is provided.

A Time-Deintleaver with embedded memory having a word length greater than a received word length is provided.

In a TDS-OFDM receive, a Time-Deintleaver with embedded memory having a word length greater than a received word length is provided.

A Time-Deintleaver with embedded memory having a ratio of word length with a received word length equal to 4:3 is provided.

In a TDS-OFDM receive, a Time-Deintleaver with embedded memory having a ratio of word length with a received word length equal to 4:3 is provided.

A Time-Deintleaver with embedded RAM having less footprint, consumes less power, or not subject to external memory shortage is provided.

In a TDS-OFDM receiver, a Time-Deintleaver with embedded RAM having less footprint, consumes less power, or not subject to external memory shortage is provided.

A Time-Deintleaver with embedded eDRAM having less footprint, consumes less power, or not subject to external memory shortage is provided.

In a TDS-OFDM receiver, a Time-Deintleaver with embedded eDRAM having less footprint, consumes less power, or not subject to external memory shortage is provided.

An apparatus is provided that has a processor for processing interleaved data; and an embedded memory coupled to the processor and forming integral, physical unit with the processor for processing the interleaved data. The apparatus forms part of a wireless receiver.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a receiver in accordance with some embodiments of the invention.

FIG. 2A is a first example of a set of schemes in accordance with some embodiments of the invention.

FIG. 2B is a second example of a set of schemes in accordance with some embodiments of the invention.

FIG. 3 is an example of a de-interleaver in accordance with some embodiments of the invention.

FIG. 4 is an example of a more detailed depiction of the de-interleaver of FIG. 3 in accordance with some embodiments of the invention.

FIG. 5 is an example of a first sachem in accordance with some embodiments of the invention.

FIG. 6 is an example of a second scheme in accordance with some embodiments of the invention.

FIG. 7 is an example of a third scheme in accordance with some embodiments of the invention.

FIG. 8 is an example of a flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a time-deintleaver having Time-Deintleaver with embedded memory having less footprint, consumes less power, or not subject to external memory shortage. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of Time-Deintleaver with embedded memory having less footprint, consumes less power, or not subject to external memory shortage described herein. The non-processor circuits may include, but are not limited to, a radio receiver, a radio transmitter, signal drivers, clock circuits, power source circuits, and user input devices. As such, these functions may be interpreted as steps of a method to perform time-deintleaving with embedded memory having less footprint, consumes less power, or not subject to external memory shortage. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

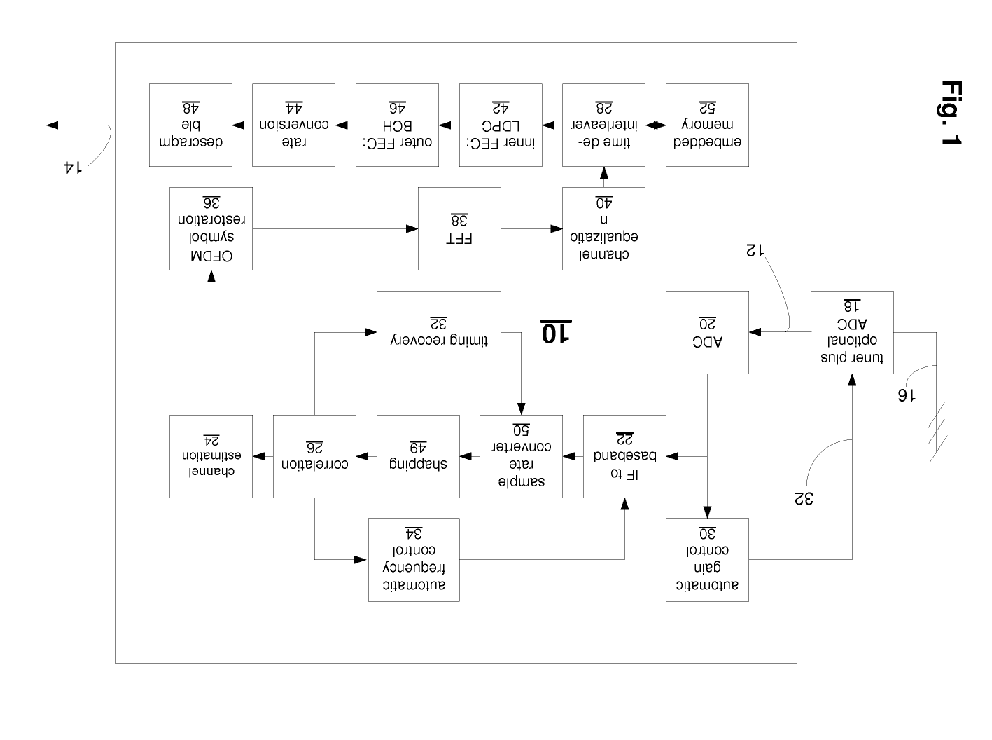

Referring to FIG. 1, a receiver 10 for implementing a LDPC based TDS-OFDM communication system is shown. In other words, FIG. 1 is a block diagram illustrating the functional blocks of an LDPC based TDS-OFDM receiver 10. Demodulation herein follows the principles of TDS-OFDM modulation scheme. Error correction mechanism is based on LDPC. The primary objectives of the receiver 10 is to determine from a noise-perturbed system, which of the finite set of waveforms have been sent by a transmitter and using an assortment of signal processing techniques to reproduce the finite set of discrete messages sent by the transmitter.

The block diagram of FIG. 1 illustrates the signals and key processing steps of the receiver 10. It is assumed that the input signal 12 to the receiver 10 is a down-converted digital signal. The output signal 14 of receiver 10 is a MPEG-2 transport stream. More specifically, the RF (radio frequency) input signals 16 are received by an RF tuner 18 where the RF input signals are converted to low-IF (intermediate frequency) or zero-IF signals 12. The low-IF or zero-IF signals 12 are provided to the receiver 10 as analog signals or as digital signals (through an optional analog-to-digital converter 20).

In the receiver 10, the IF signals are converted to base-band signals 22. TDS-OFDM demodulation is then performed according to the parameters of the LDPC (low-density parity-check) based TDS-OFDM modulation scheme. The output of the channel estimation 24 and correlation block 26 is sent to a time de-interleaver 28 and then to the forward error correction (FEC) block. The output signal 14 of the receiver 10 is a parallel or serial MPEG-2 transport stream including valid data, synchronization and clock signals. The configuration parameters of the receiver 10 can be detected or automatically programmed, or manually set. The main configurable parameters for the receiver 10 include: (1) Sub carrier modulation type including: QPSK, 16QAM, 64QAM; (2) FEC rate including: 0.4, 0.6 and 0.8; (3) Guard interval having: 420 or 945 symbols; (4) Time de-interleaver mode including three modes respectively having: 0, 240 or 720 symbols; (5) Control frames detection; and (6) Channel bandwidth including: 6, 7, or 8 MHz.

The functional blocks of the receiver 10 are described as follows.

Automatic gain control (AGC) block 30 compares the input digitized signal strength with a reference. The difference is filtered and the filter value 32 is used to control the gain of the amplifier 18. The analog signal provided by the tuner 12 is sampled by an ADC 20. The resulting signal is centered at a lower IF. For example, sampling a 36 MHz IF signal at 30.4 MHz results in the signal centered at 5.6 MHz. The IF to Baseband block 22 converts the lower IF signal to a complex signal in the baseband. The ADC 20 uses a fixed sampling rate. Conversion from this fixed sampling rate to the OFDM sample rate is achieved using the interpolator in block 22. The timing recovery block 32 computes the timing error and filters the error to drive a Numerically Controlled Oscillator (not shown) that controls the sample timing correction applied in the interpolator of the sample rate converter.

There can be frequency offsets in the input signal 12. The automatic frequency control block 34 calculates the offsets and adjusts the IF to baseband reference IF frequency. To improve capture range and tracking performance, frequency control is done in two stages: a coarse stage and a fine stage. Since the transmitted signal is square root raised cosine filtered, the received signal will be applied with the same function. It is known that signals in a TDS-OFDM system include a PN sequence preceding the IDFT symbol. By correlating the locally generated PN with the incoming signal, it is easy to find the correlation peak (so the frame start can be determined) and other synchronization information such as frequency offset and timing error. Channel time domain response is based on the signal correlation previously obtained. Frequency response is taking the FFT of the time domain response.

In TDS-OFDM, a PN sequence replaces the traditional cyclic prefix. It is thus necessary to remove the PN sequence and restore the channel spreaded OFDM symbol. Block 36 reconstructs the conventional OFDM symbol that can be one-tap equalized. The FFT block 38 performs a fixed point FFT such as a 3780 point FFT. Channel equalization 40 is carried out from the FFT 38 transformed data based on the frequency response of the channel. De-rotated data and the channel state information are sent to FEC for further processing.

In the TDS-OFDM receiver 10, the time-deinterleaver 28 is used to increase the resilience to spurious noise. The time-deinterleaver 28 is a convolutional de-interleaver which needs a memory with size B*(B−1)*M/2, where B is the number of the branch, and M is the depth. For the TDS-OFDM receiver 10 of the present embodiment, there are three modes of time-deinterleavering. For mode 1 B=52, M=48, mode 2 B=52, M=240, and for mode 3, B=52, M=720.

The LDPC decoder 42 is a soft-decision iterative decoder for decoding, for example, a Quasi-Cyclic Low Density Parity Check (QC-LDPC) code provided by a transmitter (not shown). LDPC decoder 42 is configured to decode at 3 different rates (i.e. rate 0.4, rate 0.6 and rate 0.8) of QC_LDPC codes by sharing the same piece of hardware. The iteration process is either stopped when it reaches the specified maximum iteration number (full iteration), or when the detected error is free during error detecting and correcting process (partial iteration).

The TDS-OFDM modulation/demodulation system is a multi-rated system based on multiple modulation schemes (e.g. QPSK, 16QAM, 64QAM), and multiple coding rates (0.4, 0,6, and 0.8), where QPSK stands for Quad Phase Shift Keying and QAM stands for Quadrature Amplitude Modulation. The output of BCH decoder 46 is bit by bit. According to different modulation schemes and coding rates, the rate conversion block 44 combines the bit output of BCH decoder 46 to bytes, and adjusts the speed of byte output clock to make the receiver 10's MPEG packets outputs evenly distributed during the whole demodulation/decoding process.

The BCH decoder 46 is designed to decode codes such as BCH (762, 752) code, which is the shortened binary BCH code of BCH (1023, 1013). The generator polynomial is x̂10+x̂3+1.

Since the data in the transmitter has been randomized using a pseudo-random (PN) sequence before BCH encoder (not shown), the error corrected data by the LDPC/BCH decoder 46 must be de-randomized. The PN sequence is generated by the polynomial 1+x¹⁴+x¹⁵, with initial condition of 100101010000000. The de-scrambler/de-randomizer 48 will be reset to the initial condition for every signal frame. Otherwise, de-scrambler/de-randomizer 48 will be free running until reset again. The least significant 8-bit will be XORed with the input byte stream.

The data flow through the various blocks of the modulator is as follows. The received RF information 16 is processed by a digital terrestrial tuner 18 which picks the frequency bandwidth of choice to be demodulated and then downconverts the signal 16 to a baseband or low-intermediate frequency. This downconverted information 12 is then converted to the Digital domain through an analog-to-digital data converter 20.

The baseband signal after processing by a sample rate converter 50 is converted to symbols. The PN information found in the guard interval is extracted and correlated with a local PN generator to find the time domain impulse response. The FFT of the time domain impulse response gives the estimated channel response. The correlation 26 is also used for the timing recovery 32 and the frequency estimation and correction of the received signal. The OFDM symbol information in the received data is extracted and passed through a 3780 FFT 38 to obtain the symbol information back in the frequency domain. Using the estimated channel estimation previously obtained, the OFDM symbol is equalized and passed to the FEC decoder.

At the FEC decoder, the time-deinterleaver block 28 performs a deconvolution of the transmitted symbol sequence and passes the 3744 blocks to the inner LDPC decoder 42. The LDPC decoder 42 and BCH decoders 46 which run in a serial manner take in exactly 3780 symbols, remove the 36 TPS symbols and process the remaining 3744 symbols and recover the transmitted transport stream information. The rate conversion 44 adjusts the output data rate and the de-randomizer 48 reconstructs the transmitted stream information. An embedded memory 52 coupled to the receiver 10 provides memory therein on a predetermined or as needed basis.

In an embodiment, the 36 TPS symbols should be removed before processed by time-deinterleaver. The number of symbols in each frame should be multiple of 52 (parameter B) for easy frame synchronization. The number 3744 is the multiple of 52, not 3780.

An embedded eDRAM, typically available from the selected ASIC Foundry vendor, is elected in a preferred embodiment of the present invention. This eDRAM is integrated into the same chip with other blocks used in the TDS-OFDM receiver. Since the data width of the available eDRAM block is generally 2ⁿ, like 16, 32, etc, and the data-width of the time-deinterleaver in the TDS-OFDM receiver is 24-bits. Reconciliation between the two is required. In order to save hardware cost, the invention uses 32-bits eDRAM to realize the storage requirement of 24-bits data. This is achieved by sharing the 32-bits location among data formally using 24-bits location, which thereby need to be stored in different time slots. With a result that the total amount of memory bits used is still the number calculated when a 24-bits of memory is used.

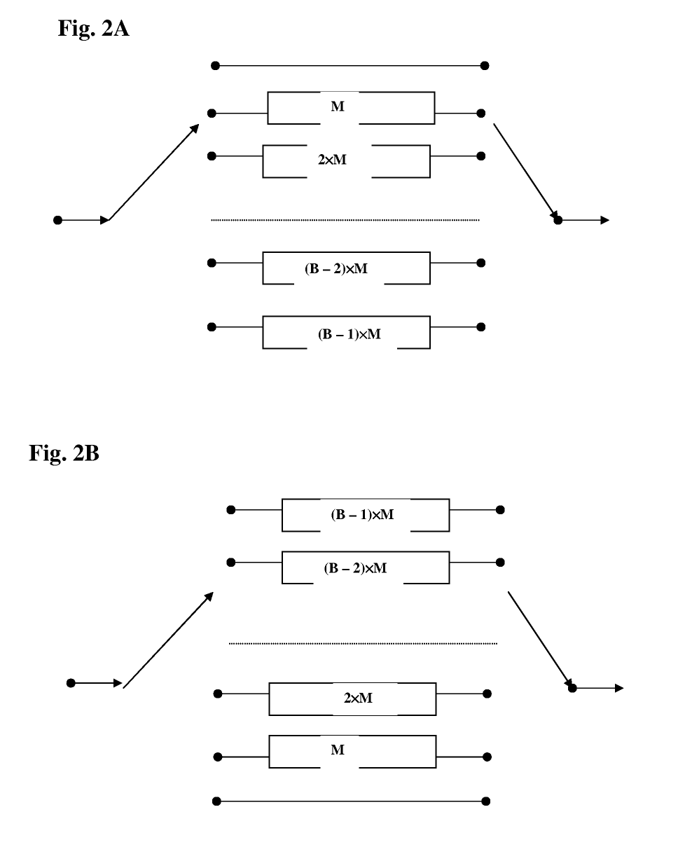

An Introduction to Time-Deinterleaver. Since on the transmitter side, time-interleaver module is used after FEC (forward error correction), but before FFT (fast Fourier transform). And it only functions on 3744 FEC encoded symbols, on the receiver side, Time-Deinterleaver 28 is inserted after FFT module 38 but before the LDPC (low density parity check) block 42 and block 46. it should be noted that the above numbers are provided to fit a specific example or case in which for each OFDM-frame, there is the associated 3744 FEC encoded symbols. But it does not mean the instant invention can only be used in 3744 symbols or some specified number of symbols. Although the numbers do dependent upon what is defined in an associated standard or what is transmitted on the transmitter side. It is comtemplated that the time-deinterleaver can be used in any convolutional deinterleavers with any value of parameters of B and M In order to shorten the frame synchronization time, a convolutional interleaver scheme is used for Time-interleaving on the transmitter side. The scheme is shown in FIGS. 2A-2B wherein a time interleaver/de-interleaver pair is depicted. In FIG. 2A the time interleaver is shown. In FIG. 2B the time de-interleaver is shown. The variable B denotes interleave width (branches) and the variable M means the interleave depth (size for delay buffers). The total delay of the interleave/de-interleave pair can be calculated from M×(B−1)×B. For the time-deinterleaver used herein, there are 3 modes used or implemented.

In Mode 1: M=48, B=52;

In Mode 2: M=240, B=52; and

In Mode 3: M=720, B=52.

As can be seen, the total time delays introduced by Time interleaver/de-interleaver pair for the three modes are respectively one hundred twenty seven thousand two hundred ninety six (127,296), six thirty six thousand four hundred eighty (636,480), and one million nine hundred and nine thousand four hundred fourth (1,909,440) symbol clock cycles.

For hardware implementation of this embodiment, the Time-Deinterleaver has fifty two (52) branches. Each of the branches has a delay line or FIFO (first in, first out) device with a different time delay. For example, for in mode 1, the bottom branch has a zero delay (as opposed to Time-Interleaver), while the top branch has a 2448-symbol clock delay. For each input valid clock cycle, one Time-Deinterleaver input data is pushed into the FIFOs from the left side, at the same time, a data is read out from the right side of the FIFOs. The sequence of the operation is as follows: the first input data is pushed into the left side of the first branch, which is the (B−1)×M FIFO. In turn, the first out data is read out from the right side of the same branch. The second data is pushed into the left side of the second branch, which is (B−2)×M FIFO. In turn, the second out data is read out from the right side of the same branch, the third . . . , etc. Because there is no time delay in the 52th branch, the input data is directly sent out without storing. Then the process goes back to first branch again and the whole process repeats itself.

Initially, before the data used by the present invention are pushed completely (all the way) into all the FIFOs, data read out are simply useless and discarded. In other words, before the 52 delay lines become all available on the right side (i.e. the first-in useful information contained within the FIFOs), data read out are simply discarded. When the data pushed into the 52 delay lines become available on the right side respectively at the right end of the FIFOs, start send out data read from the 52 delay lines (which corresponds to one hundred twenty seven thousand two hundred ninety six (127,296) clock cycle delays for mode 1; six thirty six thousand four hundred eighty (636,480) clock cycle delays for mode 2; and one million nine hundred and nine thousand four hundred fourth (1,909,440) clock cycle delays fro mode 3 respectively.

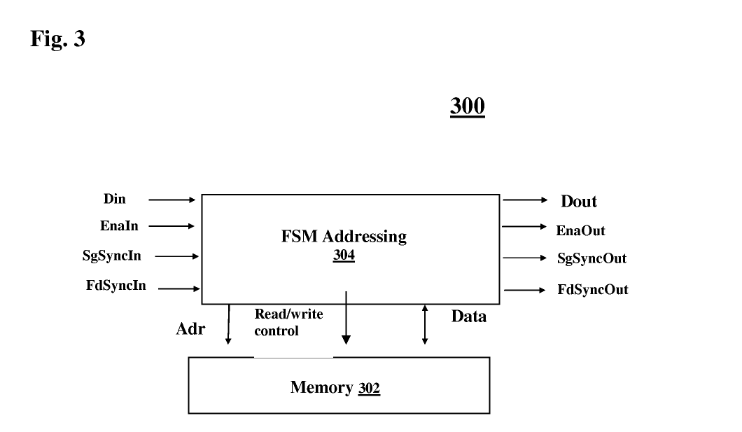

Referring to FIG. 3, in a preferred embodiment 300, instead of using fifty-one (51) separate memories to realize the 51 nonzero delay lines as shown in FIGS. 2A-2B, all of the nonzero 51 delay lines are implemented using a single piece of RAM 302. Although the single RAM 302 is used, different associated memory locations are provided therein. The addressing and FSM block 304 controls the input data, Din, and stores same to the corresponding memory location in the memory block 302. At the same time, a data in the memory is loaded to Dout as output. The total size of the memory needed are (B−1)×B×M/2×(# of Bits per symbol). For the above mentioned three (3) modes time-deinterleaver, the sizes of the memory units required are 63,648, 318,240 and 954,720 symbols respectively. For the present invention, since the data width of each symbol is 24 bits, if it is required to realize all 3 modes in one piece of memory, the total memory bits required are 22,913,280 bits.

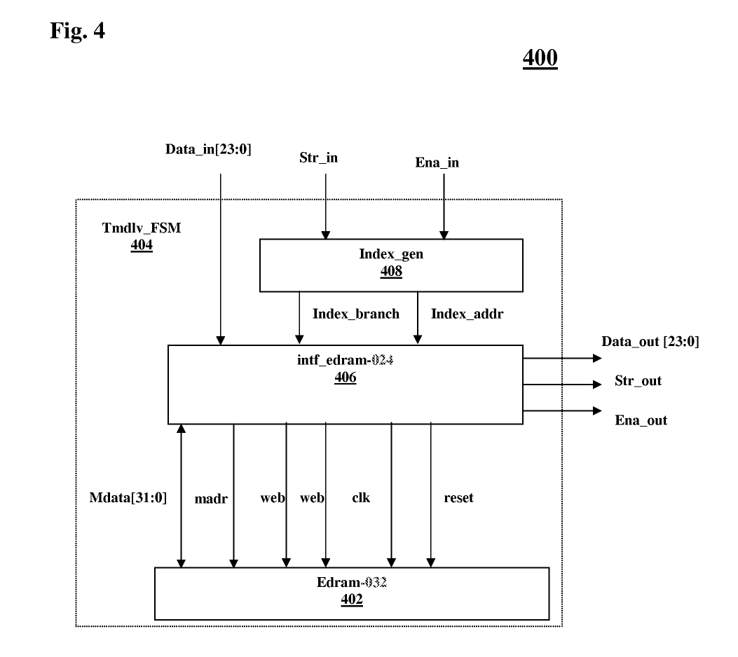

Referring to FIG. 4, an introduction 400 of synchronous DRAM 402 in association with a processor such as a finite state machine 404 is provided. finite state machine 404 comprises two sub-blocks, i.e., Index_gen 408 and intf_edram 406 respectively. Index_gen 408 functions according to a pre-selected Time-Deinterleaver mode and a 24-bits DRAM memory partition. Index_gen 408 generates the branch index (index_branch) and the memory access address (index_addr) signals corresponding to a 24-bits memory. The index_branch signal starts from B−1, decrement by 1 each time until it becomes “0”, then goes back to B−1 and so on and so forth. The index_addr is allocated as follows: “0” corresponds to the first location of branch-1, “1” corresponds to the second location of branch-1, . . . “M−1” corresponds to the Mth location of branch-1; “M” corresponds to the first location of branch-2, “M+1” corresponds to the second location of branch-2 . . . “M×(B−1)×B−1” corresponds to the last location of branch B−1.

intf_edram 406 generates the real eDRAM input/output control, address and read/write data signals for accessing the 32-bits eDRAM. It gets data (Data_in) from Time_Deintlerlever input data. According to the original 24-bits memory address obtained from index_gen module, calculates the real 32-bits memory locations using the strategy proposed by the current invention, read out the correct 24-bits data previous stored in the eDRAM to generate the final Time-Deinterleaver outputs (Data_out), then write the new data (Data_in) into the same bit and same memory location from where the previous stored data is read out. Data_in comprises the 24 bits time-deinterleaver input data. Ena_in functions in that when its value is high, the input data to the time-deinterleaver is valid data. Str_in function to indicate the first valid input data of each frame (here each frame has 3744 symbols) to the time-deinterleaver.

Data_out comprises the 24 bits time-deinterleaver output data. Ena_out functions in that when its value is high, the output data from the time-deinterleaver is valid. Str_out indicate the first valid output data of each frame from the time-deinterleaver.

It should be noted that any micro-controller having the requisite speed is contemplated in the present invention. To implement the Time-Deinterleaver, either a single chip with 2097152×32 bits (totally 67108864 bits) is used, or it can be separated into several small piece of memory with 32 bits width, depending on the parts availability from the ASIC vendor.

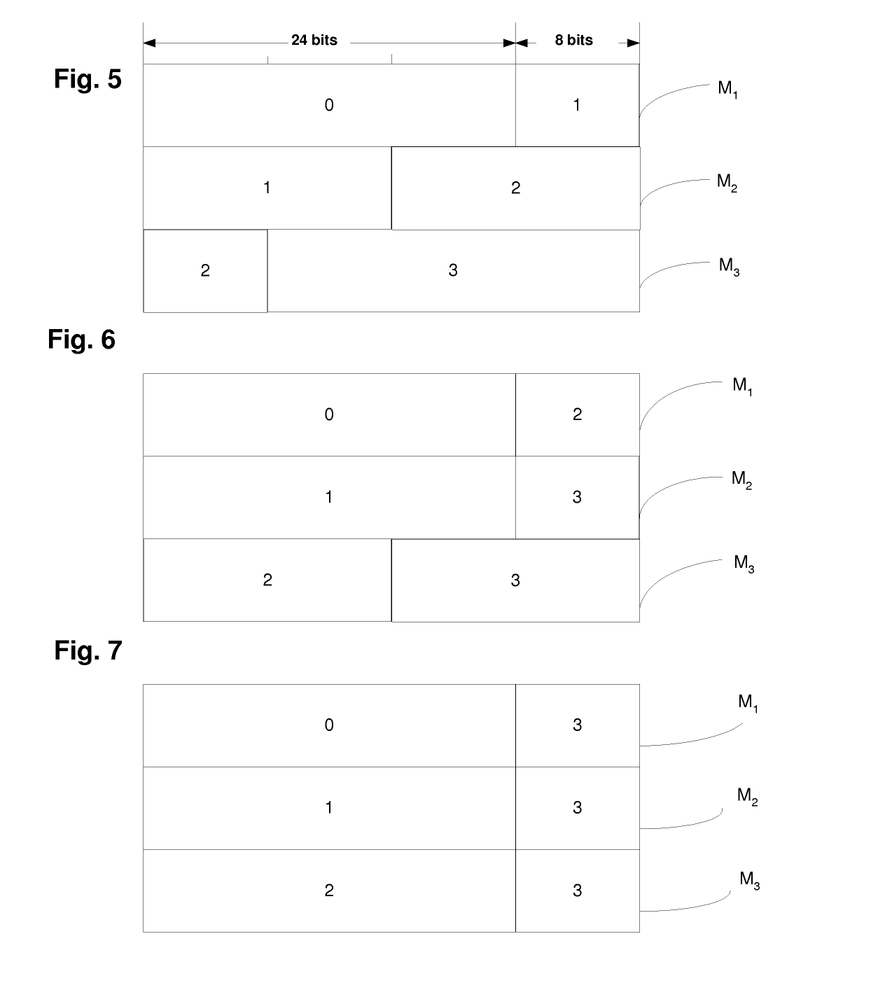

Referring to FIG. 5, a first preferred embodiment of the present invention is shown. To efficiently fit a sequence of 24-bit words with a 32-bit memory, each set of four words is split, or not split to fit into three memory locations. The set of four words are defined as 0, 1, 2, and 3 or W₀, W₁, W₂, and W₃ respectively. In the first preferred embodiment, W₀ and W₃ are intact or not split. On the other hand, W₁ and W₂ are split. The split is in a unit-of-8 manner, e.g. the first 8-bits of W₁ is positioned at lower bit end of the first 32-bit memory position M₁, along with the whole word of word zero W₀. In other words, in memory position M₁, the higher 24-bits are taken by W₀, and the lower 8 bits by part of W₁. Further, in memory position M₂, the higher 16-bits are taken by part of W₁, and the lower 16 bits by part of W₂. Still further, in memory position M₃, the higher 8-bits are taken by part of W₂, and the lower 24 bits by part of W₃.

The following are practical examples (Tm_div example) of the first embodiment.

### EXAMPLE I

A=0X2D0 the equivalent decimal number being 720.

DIN=401FEE

C=(A>>2)X3=0X21C the equivalent decimal number being 540

Because A[1:0]=2′b00

In address 0X21C: rdata=[21 c]=0x43604F43

Therefore, Dout=0x43604F

Wdata [21 c]=0x401FEE43

### EXAMPLE II

A=0X2D1 the equivalent decimal number being 721.

DIN=0x405FF0

C=(A>>2)X3=0X21C the equivalent decimal number being 540

C+1=21D (the equivalent decimal number being 541)

Because A[1:0]=2′b01

In address

0X21C: rdata=[21 c]=0x401FEE43 note the 24-bits MSB(0x401FEE) is kept, but the 8-bits LSB(0x43) is replaced with Din[23:16], which is 0x40

0X21D: rdata=[21 D]=0x23B04061 note the 16-bits MSB(0x23B0) is replaced with Din[15:0], which is 0x5FF0, but the 16-bits LSB(0x4061) is kept

Therefore, Dout=4323B0; Wdata [21 c]=401FEE40

Wdata [21 D]=5FF04061

### EXAMPLE III

A=2D2 the equivalent decimal number being 722.

DIN=0x40DDF1

C=(A>>2)X3=21C the equivalent decimal number being 540

C+1=221D (the equivalent decimal number being 541)

C+2=21E (the equivalent decimal number being 542)

Because A[1:0]=2

In address

21D (541) rdata=0x5FF04061, we keep the 16-bits MSB(0x5FF0) is kept, and 16-bits LSB replaced with Din[23:8] (0x40DD)

21E (542) rdata=0xCF40DC0F, note the 24-bits LSB (0x40DC0F) is kept, and the 8-bits MSB replaced with Din[7:0] (0xF1)

Therefore, Dout=4061CF

Wdata [21 D]=5FF040DD Wdata [21 E]=F140DC0F

### EXAMPLE IV

A=2D3 the equivalent decimal number being 723.

DIN=40202F

C=(A>>2)X3=21C the equivalent decimal number being 540

C+11=21D (the equivalent decimal number being 541)

C+2=21E (the equivalent decimal number being 542)

Because A[1:0]=2′b11=3

In address

21E (542) rdata=[21 E]=F140DC0F, note the 8-bits MSB (0xF1) is kept and the 24-bits LSB replaced by Din[23:0] (0x40202F)

Therefore, Dout=40DC0F

Wdata [21 E]=F140202F

Referring to FIG. 6, a second preferred embodiment of the present invention is shown. To efficiently fit a sequence of 24-bit words with a 32-bit memory, each set of four words is split, or not split to fit into three memory locations. The set of four words are defined as 0, 1, 2, and 3 or W₀, W₁, W₂, and W₃ respectively. In the second preferred embodiment, W₀ and W₁ are intact or not split. On the other hand, W₂ and W₃ are split. The split is in a unit-of-8 manner. e.g. the first 8-bits of W₂ is positioned at lower bit end of the first 32-bit memory position M₁, along with the whole word of word zero W₀. In other words, in memory position M₁, the higher 24-bits are taken by W₀, and the lower 8 bits by part of W₂. Further, in memory position M₂, the higher 24-bits are taken by W₁, and the lower 8 bits by part of W₃. Still further, in memory position M₃, the higher 16-bits are taken by part of W₂, and the lower 16 bits by part of W₃.

Referring to FIG. 7, a third preferred embodiment of the present invention is shown. To efficiently fit a sequence of 24-bit words with a 32-bit memory, each set of four words is split, or not split to fit into three memory locations. The set of four words are defined as 0, 1, 2, and 3 or W₀, W₁, W₂, and W₃ respectively. In the third preferred embodiment, W₀, W₁, and W₂ are intact or not split. On the other hand, W₃ is split. The split is in a unit-of-8 manner. In memory position M₁, the higher 24-bits are taken by W₀, and the lower 8 bits by part of W₃. Further, in memory position M₂, the higher 24-bits are taken by W₁, and the lower 8 bits by part of W₃. Still further, in memory position M₃, the higher 24-bits are taken by W₂, and the lower 8 bits by part of W₃.

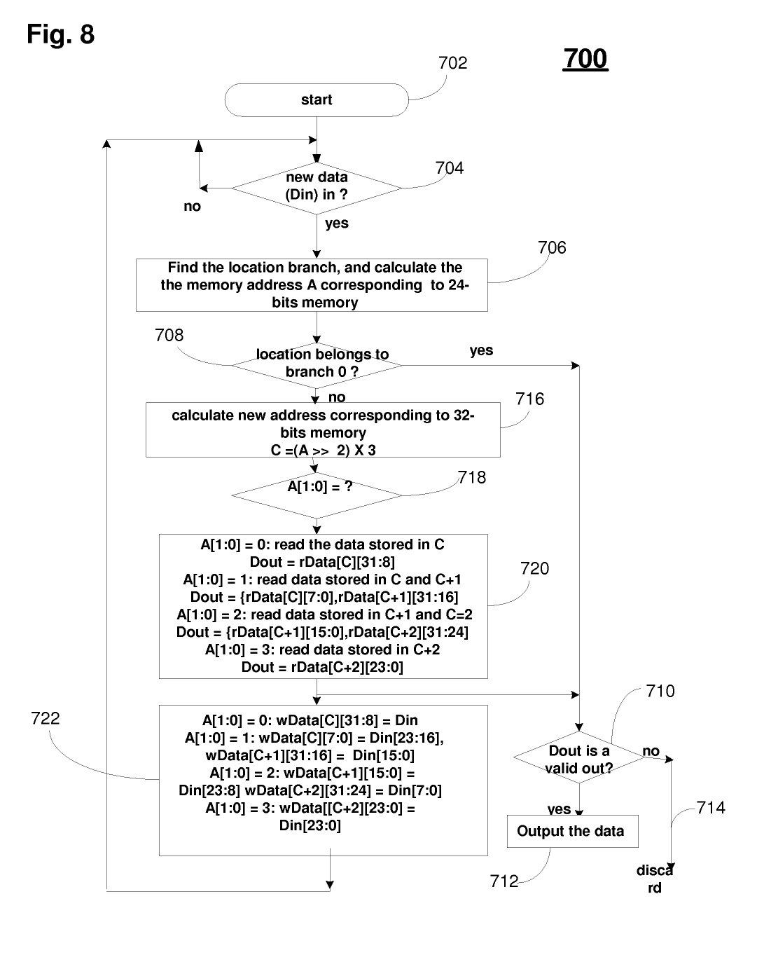

Referring to FIG. 8, a flowchart 700 suitable for implementing a computerized method for FIG. 5 scheme is provided. The process 700 starts (Step 702). A determination is made regarding the incoming data. If the data is new proceed further; if not new, revert back to step 702 (Step 704). If new data, find the location branch, and calculate a memory address A corresponding to 24-bits memory (Step 706). If the location belongs to branch 0, proceed to step 710, otherwise proceed to step 716 (Step 708). If the location belongs to branch 0, a determination is made as to whether Dout is a valid out (Step 710). If true (a valid out), data is outputted (Step 712). Otherwise, data is discarded (Step 714).

Reverting back to step 708, if location does not belong to branch 0, calculate new address corresponding to 32-bits memory C=(A>>2) X 3 (Step 716). A determination of what A[1:0] is (A[1:0]=?) is performed (Step 718). If A[1:0]=0: read the data stored in C Dout=rData[C][31:8]; if A[1:0]=1: read data stored in C and C+1; Dout={rData[C][7:0],rData[C+1][31:16]; If A[1:0] 2: read data stored in C+1 and C+2; and Dout={rData[C+1][15:0], rData[C+2][31:24]; If A[1:0]=3: read data stored in C+2; and Dout=rData[C+2][23:0] (Step 720). At this juncture, a step 710 determination is performed. Furthermore, if A[1:0]=0: wData[C][31:8]=Din; if A[1:0]=1:wData[C][7:0]=Din[23:16], and wData[C+1][31:16]=Din[15:0]; if A[1:0]=2: wData[C+1][15:0]=Din[23:8] wData[C+2][31:24]=Din[7:0]; if A[1:0]=3: wData[[C+2][23:0]=Din[23:0] (Step 722). Process 700 reverts back to step 702.

The real application will not be limited to the eDRAM, can be expanded to any RAM that with only 32-bits parts available, but we only use 24-bits of it.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to close ended or limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. An apparatus comprising:
a processor for processing interleaved data; and
an embedded memory coupled to the processor and forming integral, physical unit with the processor for processing the interleaved data.

2. The apparatus of claim 1, wherein the apparatus comprises a Time-Deintleaver.

3. The apparatus of claim 1, wherein the processor comprises a finite state machine.

4. The apparatus of claim 1, wherein the embedded memory comprises a single chip embedded memory having a greater data width than an inputted data.

5. The apparatus of claim 1, wherein the embedded memory comprises memory adapted to accommodate 32-bits data width to thereby store 24-bits data width data free from increasing total memory size.

6. A receiver comprising:
an apparatus comprising:
a processor for processing interleaved data; and
an embedded memory coupled to the processor and forming integral, physical unit with the processor for processing the interleaved data.

7. The receiver of claim 6, wherein the apparatus comprises a Time-Deintleaver.

8. The receiver of claim 6, wherein the processor comprises a finite state machine.

9. The receiver of claim 6, wherein the embedded memory comprises a single chip embedded memory having a greater data width than an inputted data.

10. The receiver of claim 6, wherein the embedded memory comprises memory adapted to accommodate 32-bits data width to thereby store 24-bits data width data free from increasing total memory size.
